(19) United States
(12) Patent Application Publication
(10) Pub. No.: US 2026/0311979 A1
(43) Pub. Date: Oct. 8, 2026

(54) PARTICLE DETECTORS BASED ON DIRECT CONVERSION AT THE SURFACE OF A DENSE MEDIUM

(71) Applicants: The University of Chicago, Chicago, IL (US); Southwest Research Institute, San Antonio, TX (US)

(72) Inventors: Henry J. Frisch, Chicago, IL (US); Bernard W. Adams, Naperville, IL (US); Kepler Domurat-Sousa, East Lansing, MI (US); Cameron Poe, Dallas, TX (US); Camden Ertley, Boerne, TX (US); Neal Sullivan, Lunenburg, MA (US)

(21) Appl. No.: 19/481,648

(22) PCT Filed: Jun. 5, 2024
(86) PCT No.: PCT/US2024/032588

§ 371 Date: Nov. 5, 2025

Related U.S. Application Data
(60) Provisional application No. 63/471,364, filed on Jun. 6, 2023.
(60) Provisional application No. 63/471,320, filed on Jun. 6, 2023.
(60) Provisional application No. 63/600,884, filed on Nov. 20, 2023.

(51) Int. Cl. H01J 43/24

(52) U.S. Cl. CPC H01J 43/246

(57) ABSTRACT

Particle detectors, including gamma ray detectors and neutron detectors, are provided. Also provided are methods of using the detectors to detect particle radiation. The particle detectors use a layer of a particle conversion material to convert incident particles directly into primary electrons or other non-photon particles, such as alpha particles, protons, tritons, gamma rays, or fission products, without the use of a scintillator. The primary electrons and other non-photon particles generate secondary electrons in a secondary electron emission material, and these secondary electrons undergo amplification to generate a secondary electron shower that can be converted into an electronic signal by one or more anodes.

### CROSS-REFERENCE TO RELATED APPLICATIONS

The present application claims priority to U.S. provisional patent application No. 63/471,320 that was filed on Jun. 6, 2023, U.S. provisional patent application No. 63/471,364 that was filed on Jun. 6, 2023, and U.S. provisional patent application No. 63/600,884 that was filed on Nov. 20, 2023, the entire contents of each of which are incorporated herein by reference.

### BACKGROUND

Gamma ray detectors are used in a variety of applications, such as medical imaging. In conventional gamma ray detectors, the detection of the gamma rays is typically based on the production of optical photons in a scintillating medium, followed by the conversion of the photons into electrons.

Positron-Emission Tomography (PET) in an example of a medical imaging technique based on gamma ray detection. PET uses radioactive positron-emitting tracers to locate areas of high biological activity, such as tumors and hair-line fractures of bones, or to develop pharmaceuticals or medical treatments. In PET, a positron emitted by a radioactive nucleus is scattered and loses energy in the patient, ending by annihilating an electron (positron-electron (e⁺e⁻) annihilation). The annihilation produces a pair of gamma rays, each with the energy of the mass of the electron (positron), 511 keV. To form an image, a line is constructed between the conversion points of the two gamma rays, the ‘Line-of-Response’ (LOR). The image of the locations of the annihilations is reconstructed from a superposition of the collection of the LORs from multiple events. Resolution on the width of the LOR is referred to as transverse resolution and along the LOR as longitudinal resolution.

Time-of-flight (TOF) is used to locate the annihilation point along the LOR by measuring the relative arrival times of the two gamma rays. The uncertainty along the LOR (longitudinal resolution) depends both on the TOF resolution and the uncertainty in the depth of interaction (DOI) in the scintillating medium.

The transverse resolution in PET is currently set by details of the detector construction and not by fundamental physics processes. Today's PET detectors are composed of high-density crystals that are appreciably larger transversely than the characteristic scattering and interaction lengths of the particles involved. The length of the crystals also contributes uncertainty on the DOI in a crystal, introducing parallax into the transverse spatial resolution, as well as limiting the efficiency for detection.

Unfortunately, due to limitations on the spatial and temporal resolution and gamma ray conversion efficiencies of conventional PET detectors, high radiation doses to the patient are required. The large radiation dose to the patient in PET precludes it being standard practice for screening for wide-spread early detection of tumors or other pathologies and counter-indicates use on children, the elderly, and other vulnerable populations, or repeated exposures. In addition, because PET requires the production and transport of radioactive tracers, such as ¹⁸F, which typically have a short half-life, PET scanners are typically limited to large institutions in urban areas. A reduction in radiation dose would, therefore, broaden the use of PET in rural and under-served communities world-wide.

PET is also used in the development of pharmaceuticals, in which large numbers of small animals are scanned. Both the spatial resolution and system throughput are target parameters for improvement using higher spatial and time resolutions and shorter exposures.

### SUMMARY

Particle detectors, including gamma ray detectors, neutron detectors, and charged-particle detectors, are provided. Also provided are PET systems incorporating the gamma ray detectors and method for making and using the particle detectors.

One embodiment of a gamma ray detector includes: a gamma ray conversion stage comprising: a gamma ray conversion material that converts incident gamma rays directly into primary electrons via a Compton, Photoelectric, and/or Pair Production effect; and a secondary electron emission material that converts the primary electrons into secondary electrons to produce a secondary electron signal; and at least one anode configured to receive the secondary electrons and to convert the secondary electron signal into an electrical signal.

One embodiment of a PET detector is an ultra-low-dose (ULD) Time-of-Flight Positron-Emission Tomography (TOF-PET) detector comprising a gamma ray detector of a type described herein, wherein the ULD TOF-PET detector is able to detect the gamma rays with a spatial resolution of 1 mm or better and a temporal resolution of 50 psec or better.

One embodiment of a PET detector is a Time-of-Flight Positron-Emission Tomography (TOF-PET) detector comprising multiple gamma ray detectors of a type described herein.

One method of using a gamma ray detector of a type described herein includes the steps of: exposing the gamma ray conversion material to an incident gamma ray, whereby said incident gamma ray is converted directly into a primary electron via a Compton, Photoelectric, and/or Pair Production effect; converting the primary electron into secondary electrons in the secondary electron emission material to produce a secondary electron signal; and detecting the time that the first secondary electron of the secondary electron signal generated by the gamma ray arrives at the anode

One embodiment of a method of using a TOF-PET system of a type described herein to generate an image includes the steps of: placing a patient or sample that emits coincident gamma ray pairs, generated by positron-electron annihilation events, between a first one of the gamma ray detectors and a second one of the gamma ray detectors; detecting coincident gamma-ray pairs arriving at the first and second gamma ray detectors by: detecting a signal generated when a first gamma ray of a coincident gamma ray pair interacts with the gamma ray conversion material in the first detector to produce a primary electron via the Compton or Photoelectric Effect and said primary electron interacts with the secondary electron emission material in the first gamma ray detector to produce secondary electrons; and detecting a signal generated when a second gamma ray of a coincident gamma ray pair interacts with the gamma ray conversion material in the second detector to produce a primary electron via the Compton or Photoelectric Effect and said primary electron interacts with the secondary electron emission material in the second gamma ray detector to produce secondary electrons; determining the ends of a Line-of-Response (LOR) for the coincident gamma ray pair based on spatial positions of trajectories of the first and second gamma rays in the gamma ray gamma ray conversion materials of the first and second gamma ray detectors; determining the spatial position of a positron-electron annihilation event along the LOR based on arrival times of the first and second gamma rays measured by the first and second gamma ray detectors; and generating an image of a region-of-interest within the patient or sample based on the spatial distribution of the positron-electron annihilation events.

One embodiment of a neutron detector includes: a neutron conversion stage comprising: a neutron conversion material that converts incident neutrons directly into a non-photon particle or nuclei; and a secondary electron emission material that converts the non-photon particle or nuclei into secondary electrons to produce a secondary electron signal; and at least one anode configured to receive the secondary electrons and to convert the secondary electron signal into an electrical signal.

One embodiment of a method of making a particle detector of a type described herein includes the steps of: assembling the conversion stage, the amplification stage, if present, and the anode in a package at atmospheric pressure; and sealing the package.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1: An example sequence of internal active modules in a particle detector, such as a High-Resolution Gamma Multiplier Tube (HGMT). A particle, such as a gamma ray, enters from above, encountering—in turn—a top layer of a hermetic package, a conversion stage (CS), amplification stage (AS), and an anode stage, followed by the bottom layer of the package. The conversion stage may comprise discrete dynodes or one or more micro-channel plate (MCP)-based electron amplifiers. The amplification stage may include one or more MCPs. The anode may include RF microstrip lines, an array of two-dimensional pads, or other electron sensors. In some realizations of the device, the separate CS and AS sections are subsumed into a single module. The package may be rectangular and planar or shaped to fit the desired function.

FIG. 2: An example CS formed by secondary electron emission material-coated dynodes, which may be composed of a metal or comprise metal nuclei. The CS includes multiple (i.e., two or more) sequences of dynodes, each sequence comprising multiple dynodes. A voltage difference is set between each dynode in a sequence of dynodes of the multi-layer dynode structure. The number of layers may vary with an optimization of higher conversion efficiency versus time/space resolution.

FIG. 3: An illustrative lamina for constructing a laminae-based MCP (LMCP) for an AS or CS in a particle detector, such as a gamma ray or neutron detector. This lamina comprises a simple pattern of structured ridges of height α, width β, and separation γ. Multiple such lamina can be assembled into a slab to provide channels of dimension α by γ. The shaded areas represent illustrative structured coatings, such as coatings of one or more secondary electron emission materials that have a high secondary electron yield (SEY), including yields of at least 2, resistive coatings, and or metal coatings. To form a slab, the laminae are stacked in close contact on edge next to each other. Slabs may comprise non-uniform channels, may be of arbitrary shape, and need not be planar.

FIG. 4: A simplified example of a laminae-based slab that can be incorporated into an LMCP that provides an integrated CS/AS stage. The lamina thickness is determined by the range of electrons produced by surface direct conversion (SDC™) of the gamma rays in the substrate material. The substrate material density and composition can be chosen to optimize conversion, timing/space resolution, and mechanical robustness. Laminae intended for gamma ray detection may be made from a heavy-metal dielectric such as Pb-glass or W-loaded plastic, such as Pb- or W-loaded poly ether-ether-ketone (PEEK). The thickness of the slab is equal to the width of a lamina, T. Laminae are stacked on edge such that the ridges form channels between the lamina of dimension α perpendicular to the lamina and γ transverse along the lamina. The bulk laminae, which represent the largest fraction of the area of the slab, serve to convert the incoming gamma ray to an electron. Gamma rays are incident normal to the plane of the slab and traverse a path length in the material that depends on the thickness and structure of the laminae, the open area ratio (OAR), and the incident angles of the gamma ray from the normal. Simulations for gamma ray interactions in slabs composed of or comprising heavy metals are presented in the Example.

FIG. 5: An example detector assembly comprising two LMCPs formed with laminae that form structured electron-multiplier channels with entrance funnels. Each channel is of length T and transverse dimensions α by γ. The OAR is by design small to maximize the area presented to gamma rays for direct conversion to primary electrons. The path length of the gamma rays in the lamina substrate material depends on the density and elemental composition, the OAR, the thickness and structure of the laminae, and the incident angles of the gamma ray from the normal. The laminae are shown with tabs to space the LMCPs and to provide mechanical support in columns between the top window and the bottom of a hermetic package.

FIG. 6: A side-view of three implementations of an anode stage. Top: An anode stage comprising a conducting plane of impedance-controlled RF-microstrips and the corresponding ground plane. Middle: An anode stage comprising an (optional) entrance grid, a conducting plane of pads, a layer of impedance-controlled signal traces, and a ground shield. Bottom: An anode stage comprising an entrance grid, an array of solid-state sensors, one or more layers of impedance-controlled signal traces, and a ground shield.

FIG. 7: A schematic diagram of one embodiment of a whole-body PET scanner based on HGMT modules arranged around a central bore. This embodiment of the scanner is 200 cm long and has a bore radius of 45 cm, but other dimensions could be used. The front-end pattern recognition and pulse analysis and buffered readout electronics can be local on each module.

FIG. 8: A schematic of a portable PET scanner based on HGMT modules. The scanner comprises two or more HGMTs on a portable (e.g., wheeled) cart. The HGMTs can be sealed or pumped by a small pump on the cart. The HGMTs can sit on a stage adjustable in height and aperture for imaging breaks in arms or legs, for example. Local electronics and computation can give a real-time image.

FIG. 9: Left: A schematic of an economical small-animal PET scanner formed by two HGMT modules. Arrays of such scanners can be used for high throughput applications. Right: A small-animal PET scanner formed by 4 modules in azimuth.

FIG. 10: The predicted electron energy spectrum from the exit side of a thin tungsten (W) or lead-glass (Pb-glass) plate, generated by an incident 511 keV gamma ray, based on a tool for particle simulation (TOPAS), as described in the Example. The plate thickness for Pb-glass (λ_{R}=0.561 cm) is 150 microns (0.006″) and for W (λ_{R}=0.350 cm) is 50 microns (0.002″).

FIG. 11: The predicted electron yield per 511 KeV gamma ray traversing a thin plate of W (solid line) and Pb-glass (dashed-line) versus plate thickness, based on a TOPAS simulation, as described in the Example. The yield is for the exit side of the plate. The lower density of the glass is compensated by the larger depth from which electrons reach the surface.

FIG. 12: The efficiency for an electron from direct gamma conversion to exit the surface per 511 keV gamma ray versus path length in a 50 micron-thick W plate (solid line) or a 150-micron Pb-glass plate (dashed line). The efficiency is for a gamma ray propagating inside the plate versus the path length in mils (thousands of an inch; ~25 microns/mil), based on a TOPAS simulation, as described in the Example.

FIG. 13: The efficiency for the direct conversion of a 511 keV gamma ray versus incident angle φ from the normal, where φ is the angle in the plane perpendicular to the plane of the individual laminae, based on a TOPAS simulation, as described in the Example. The efficiency is defined as the creation of a primary electron that enters a channel of an MCP by crossing a functionalized channel-defining wall. Distributions are shown for MCP thicknesses of 1 cm and 2.54 cm (1 inch).

FIG. 14: The one-dimensional spatial distribution in the ‘short’ dimension of secondary emission (charge) generated by a single electron at the exit of a rectangular channel in the slab of an LMCP of the type shown in FIG. 4, based on a TOPAS simulation, as described in the Example. The channel has a uniform profile with transverse dimensions of 50 μm by 2.5 mm. The TOPAS simulation of secondary emission and multiplication is initiated at the point of a primary electron on the wall of the channel (left-hand surface in FIG. 4). The cross-hatched regions represent the spacers between neighboring channels.

FIG. 15: The one-dimensional spatial distribution in the ‘long’ dimension of secondary emission generated by a single electron at the exit of a rectangular channel in the slab of an LMCP of the type shown in FIG. 4, based on a TOPAS simulation, as described in the Example. The channel has a uniform profile with transverse dimensions of 50 μm by 2.5 mm. The TOPAS simulation of secondary emission and multiplication is initiated at the point of a primary electron on the wall of the channel (left-hand surface in FIG. 4). The cross-hatched regions represent the spacers between neighboring channels.

FIG. 16: The one-dimensional spatial distribution in the ‘long’ dimension of secondary emission generated by a single electron at the exit of a rectangular channel in the slab of an LMCP of the type shown in FIG. 4, based on a TOPAS simulation, as described in the Example. The channel has a uniform profile with transverse dimensions of 50 μm by 1.25 mm. The TOPAS simulation of secondary emission and multiplication is initiated at the point of a primary electron on the wall of the channel (left-hand surface in FIG. 4). The cross-hatched regions represent the spacers between neighboring channels.

FIG. 17: The current in the secondary electron shower at the channel exit versus time for a cascade initiated by a single secondary electron 7.5 mm from the exit end of the channel and centered on one of the short sides, based on a TOPAS simulation, as described in the Example.

FIG. 18: Illustration of the First-One-In Technique. The time of the first secondary electron of an electron shower in one channel that arrives at the exit plane of a Pb-glass slab versus the number of secondary electrons created by the primary electron from the direct gamma conversion for a LMCP of the type shown in FIG. 4, based on a TOPAS simulation, as described in the Example. The First-One-In method predicts that a higher multiplicity of initial secondary electrons improves the time resolution; the probability of seeing no electrons in the initial time interval falls exponentially with the length of the interval due to Poisson statistics. In the simulation, electrons are started one-at-a-time 7.5 mm from the exit of the channel, centered in the short direction between the two walls. Electrons exiting the plane enters the amplifying LMCP in the AS below; the resulting shower resolution will be dominated by the intrinsic time resolution of the AS.

FIG. 19: Reconstructed images of a Derenzo phantom at a dose of 150 Bq/mL for the rods, a factor of 100 lower than the benchmark for a 10-minute scan, as described in the Example. The images are based on an integrated CS/AS in the form of an LMCP with a slab thickness of 1 cm in the left-hand image and 2.54 cm (1 inch) in the right-hand image. In both cases, the background dose was set to ⅓ of that of the rods. The timing resolution was taken as 100 ps (FWHM); the spatial resolution in the plane of the LMCP slab at the channel exit was set to 1 mm in both the ‘long’ and ‘short’ dimensions (see FIGS. 14 and 15).

FIG. 20: Reconstructed images of a Derenzo phantom at a dose of 15 Bq/mL for the rods, a factor of 1000 lower than the benchmark for a 10-minute scan, as described in the Example. The images are based on an integrated CS/AS in the form of an LMCP with a slab thickness of 1 cm in the left-hand image and 2.54 cm (1 inch) in the right-hand image. In both cases, the background dose was set to ⅓ of that of the rods. The timing resolution was taken as 100 ps (FWHM); the spatial resolution in the plane of the LMCP slab at the channel exit was set to 1 mm in both the ‘long’ and ‘short’ dimensions (see FIGS. 14 and 15).

FIG. 21: Reconstructed images of the 4D Extended Cardiac Torso XCAT brain phantom with a 2-cm diameter spherical lesion at a dose reduced by a factor of 100 from the benchmark for a 10-minute scan, i.e., 82.5 Bq/mL for white matter, 330 Bq/mL for gray matter, and 990 Bq/mL for the lesion, as described in the Example. Left: Thickness of a Pb-glass laminated LMCP slab of 1 cm. Right: Thickness of a Pb-glass LMCP slab of 2.54 cm (1 inch).

FIG. 22: Reconstructed images of the XCAT brain phantom with a 2-cm diameter spherical lesion at a dose reduced by a factor of 1000 from the benchmark for a 10-minute scan, i.e., 8.25 Bq/mL for white matter, 33 Bq/mL for gray matter, and 99 Bq/mL for the lesion, as described in the Example. Left: Thickness of a Pb-glass LMCP slab of 1 cm. Right: Thickness of a Pb-glass LMCP slab of 2.54 cm (1 inch).

FIG. 23: Reconstructed images of the XCAT brain phantom with a 2-cm diameter spherical lesion at a dose reduced by a factor of 10,000 from the benchmark for a 10-minute scan, i.e., 0.825 Bq/mL for white matter, 3.3 Bq/mL for gray matter, and 9.9 Bq/mL for the lesion, as described in the Example. Left: Thickness of a Pb-glass LMCP slab of 1 cm. Right: Thickness of a Pb-glass LMCP slab of 2.54 cm (1 inch).

### DETAILED DESCRIPTION

Particle detectors, including gamma ray detectors, neutron detectors, and charged-particle (e.g., electron) detectors, are provided. Also provided are methods of using the detectors to detect particle radiation. The particle detectors use a layer of a particle conversion material to convert incident particles directly into primary electrons (in the case of gamma ray detectors) or other non-photon particles, such as positrons, alpha particles, protons, tritons, gamma rays, or fission products (in the case of neutron detectors), without the use of a scintillator. The primary electrons and other non-photon particles generate secondary electrons in a secondary electron emission material, and these secondary electrons undergo amplification to generate a secondary electron shower that can be converted into an electronic signal by one or more anodes.

The particle detectors can be constructed as large-area detectors with high resolution in space and time for the detection of gamma rays, neutrons, and other particles for a wide variety of applications. For example, some embodiments of the gamma ray detectors can be used in medical imaging devices, including PET and SPECT systems, to provide images with sub-mm spatial resolution, sub-100 psec time resolution, gains of greater than 107, and/or improved contrast-to-noise ratios. In addition, the particle detectors can be used in the development of pharmaceuticals, and other non-medical, scientific, and societal applications, as described in more detail below.

Because the particle detectors are based on the direct conversion of gamma rays, neutrons, or other particles in a direct conversion material—rather than a material that converts an electron into light—the scintillator and photodetector and photocathode subsystems that are used in conventional particle detectors can be eliminated, thereby reducing the cost and complexity of the detector, while increasing the robustness and enabling the production of light-weight detectors with a small footprint and low maintenance requirements. Moreover, the elimination of the scintillator and photodetector and photocathode systems enhances the detectors' compatibility with other imaging modalities, such as magnetic resonance imaging (MRI) or computed tomography (CT), enables novel methods of medical imaging, and, with suitable choice of parameters, can reduce the radiation dose to the patient. Benefits of a lower radiation dose include routine screening of appropriate populations for early detection of pathologies; increased use of medical imaging in diagnostics in previously underserved patient populations and communities, including screening and/or diagnosing cancers in oncology patients; and the fabrication of simpler gamma ray detectors for small low-cost portable PET scanners.

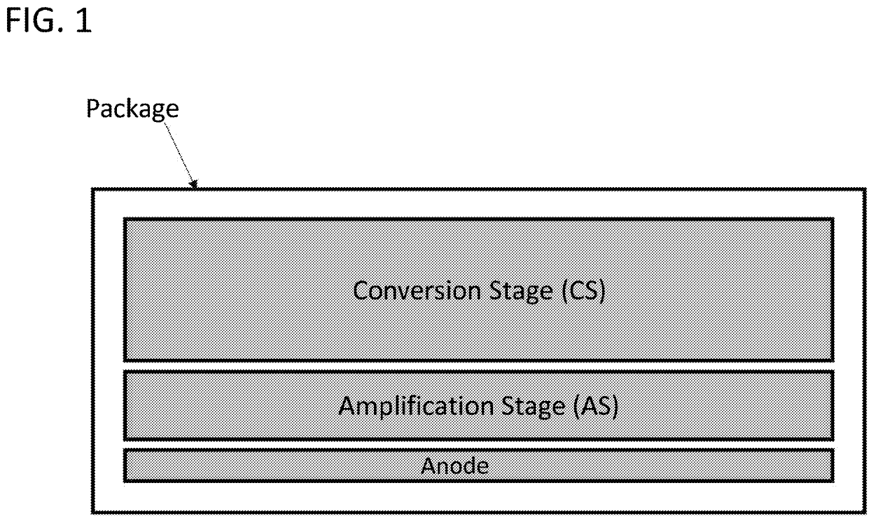

FIG. 1 shows a high-level schematic diagram of a particle detector based on the direct conversion of an incident particle to a primary electron. In the embodiment shown in FIG. 1, the detector is constructed with a sequence of active stages that are separated based on their functions and housed in a hermetic package. In this configuration, a particle, such as a gamma ray, enters from above, encountering, in turn, the top layer of the hermetic package, a conversion stage (CS), an amplification stage (AS), an anode, and the bottom layer of the hermetic package. The top layer may include a transparent entrance window for light transmission or generation of Cherenkov radiation. The CS includes: a particle-converting material that directly converts the incoming particle into a primary electron or other non-photon particle, and a secondary electron producing structure comprising a material that emits secondary electrons upon exposure to the primary electron or other non-photon particle, referred to herein as a secondary electron emission material. The AS includes a high-gain electron amplification structure, such as one or more micro-channel plates (MCP), to amplify the secondary electrons. In some embodiments of the particle detectors, the electron gain in the CS may be large enough to produce an adequate secondary electron signal at the anode without the need for the AS. In such embodiments, the AS may be omitted.

While the conversion stage and the amplification stage are depicted as distinct components in the embodiment of FIG. 1, it is possible to integrate the CS and AS into a single unit by, for example, constructing an MCP-based electron amplifier from a particle conversion material and coating at least a portion of the interior surfaces of the channels with a secondary electron emission material, as discussed in more detail below. In such embodiments, the MCP serves to directly convert an incident gamma ray (or other fast particle) into a primary electron (or other particle) and to multiply the secondary electrons generated by the primary electron (or other particle).

### Gamma Ray Detectors

The gamma ray detectors include a CS that coverts gamma rays directly into primary electrons via the Compton, Photoelectric, and/or Pair Production effects. The gamma ray detectors typically also include an AS, which may be distinct and separate from the CS, or may be integrated with the CS in a single unit. The gamma ray detectors also include an anode. Each of these components is described below.

### The Converter Stage (CS)

The CS of a gamma ray detector includes one or more thin structures comprising a gamma ray conversion material that directly converts incident gamma rays into primary electrons via the Compton, Photoelectric, and/or Pair Production effects in a thin, near-surface region of the conversion material. The primary purpose of the gamma ray conversion material is to provide enough nuclear cross section to an incident gamma ray to generate a non-photon particle, such as a primary electron. When the primary electron traverses a secondary electron emission material that is near or on the gamma ray conversion material, secondary electrons are produced. In some embodiments of the CS, one or more of the elements that make up the CS are coated with the secondary electron emission material.

The gamma ray conversion material may be a material containing or consisting of high atomic number (Z) atoms suitable for carrying out direct conversion via the photoelectric effect, although low Z atoms are also suitable, provided they are capable of direct conversion of an incident gamma ray, as described herein. Suitable gamma ray conversion materials may comprise metal nuclei, such as iron (Fe), copper (Cu), zirconium (Zr), barium (Ba), bismuth (Bi), tungsten (W) or lead (Pb). For example, dielectric materials loaded (or “doped”) with metal nuclei may be used. These include metal-loaded glasses (“metallic glasses”), such as lead-glass (Pb-Glass) or tungsten-glass (W-Glass), metal oxides, metal ceramics, and metal-loaded plastics such as polyether ether ketone (PEEK).

The practical thickness of the near-surface region in which the conversion occurs is determined by the range of the primary electron, and, because of the low electron energy, is typically less than a few percent of the radiation length (λ_{R}) of the material. (Groom, Donald E. et al., The European Physical Journal C-Particles and Fields 15.1-4 (2000): 163-173.) The ability of media comprising or consisting of heavy metal atoms to directly convert gamma rays into primary electrons in a near-surface region is illustrated in the Example, which reports the results of simulations of the interaction of gamma rays with tungsten and lead-glass substrates.

Once produced within the thin near-surface region, the primary electron created in the gamma ray conversion material escapes the gamma ray conversion material and traverses a secondary electron emission material in the secondary electron emitting structure of the CS. The secondary electron emitting material has a high secondary-emitting yield (SEY) and produces soft (low-momentum) secondary electrons. Illustrative examples of materials having a suitably high SEY include metal oxides, such as MgO, Al₂O₃, and carbon materials, such as Chemical Vapor Deposition (CVD) diamond. More information about secondary electron emission materials can be found, for example, in S. X. Tao et al., MDPI Materials, 2016, 9 (1017) and Z. Insepov, et al., Nucl. Instr. Meth A639, 155 (2011).

In some embodiments of the gamma ray detectors, the secondary electron emission material takes the form of a coating on the gamma ray conversion material. For example, in some implementations of the gamma ray detectors, the CS includes a metal dynode structure in which a dense metal, such as tungsten (W), is used as the conversion material. Other embodiments of the CS are based on dielectric dynodes in which a dielectric material loaded with metal atoms is the conversion material. In either case, the conversion material is coated with a secondary electron emission material.

### A Metal Dynode Conversion Stage

The principle of gamma ray detectors that use a metal dynode CS is that each dynode surface in a sequence of discrete dynodes is an equipotential, with increasing positive voltage between the dynodes in the sequence. The dynodes are coated with a secondary electron emission layer, such that when a primary electron generated in the gamma ray conversion material strikes the secondary electron emission coating on the dynode, secondary electrons are produced. The dynodes support an electric field to accelerate the electrons down the dynode sequence, with gain from secondary emission at each dynode, to the AS where they are multiplied at high gain. Thus, the dynode sequence provides electron multiplication through the sequence of electrons striking a dynode, secondary emission with a multiplication factor, and then electrostatic acceleration to the next dynode in the sequence. The total multiplication factor, or gain, is determined by the number of dynodes in the sequence, the SEY-coating of the dynodes, and the voltage distribution in the dynode sequence. On exiting the CS, the electrons are electrostatically accelerated to the top surface of the high-gain AS directly below. The electrons exiting the CS typically are proximity focused-that is, the electric field is normal to both the emitting and amplification surfaces which are close together and parallel.

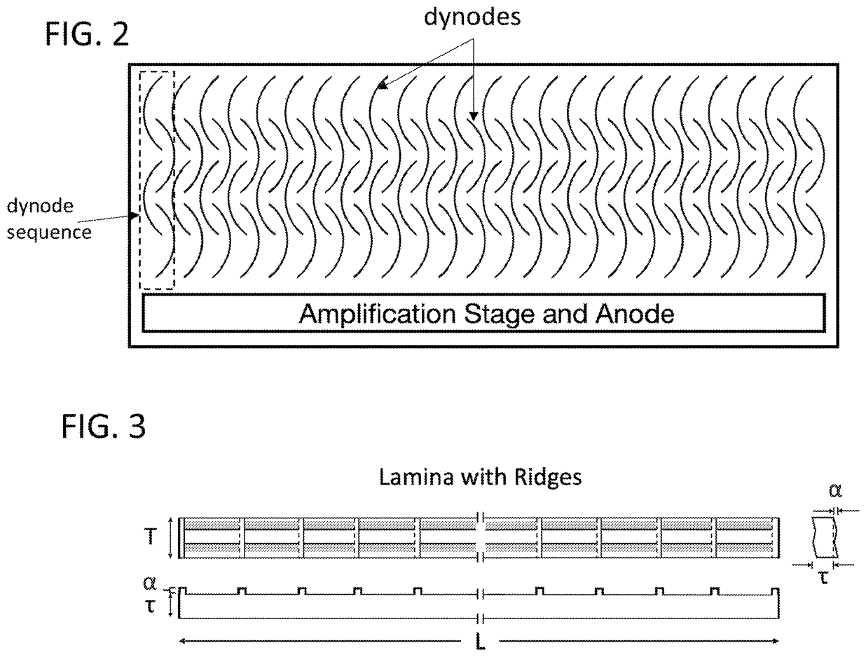

An illustrative embodiment of a gamma ray detector in which a dynode-based CS is combined with an AS and anode, such as in a commercial dynode-based photomultiplier, is shown schematically in FIG. 2. The CS assembly includes a dynode section of multiple layers of dynodes, wherein the dynodes in each successive layer are at an increasingly positive voltage, and an exit grid (e.g., grid, mesh, or wires) (not shown) at an additional voltage step. Each dynode is coated with a secondary electron emission material. Since, in a dense metal conversion medium, such as tungsten (W) or lead (Pb), electrons escape only from a region close to the surface, multiple thin layers of the conversion material are more efficient than a single bulk substrate. Each metal dynode element forms an equipotential; the electric field is normal to each dynode surface, connecting one layer to the next layer across the voltage difference. Although the illustrative embodiment shown in FIG. 2 includes an AS following the CS, the gain in the CS may be large enough to produce an adequate secondary electron signal at the anode without an AS. The converter may be in the form of custom-shaped dynodes, ribbons, slats, mesh, or other shapes.

### A Dielectric Conversion Stage

As an alternative to metal dynodes, the CS may comprise discrete structures of glass, ceramic, or other dielectrics and non-metallic materials that function as a converter of gamma rays to primary electrons via the Compton, Photoelectric, and/or Pair Production effects, followed by a separate AS.

Dielectric LMCPs with Patterned Channels

In some embodiments of the gamma ray detectors, an MCP is used as both a CS and AS—that is, the CS and AS are integrated in a single unit. In some such embodiments, the MCP is formed from laminae comprising a gamma ray conversion material and the channels of the MCP have a secondary electron emission material coating on their internal surfaces. MCPs constructed from laminae are referred to herein as LMCPs. Metallization along the interior surfaces of the channels can be used to provide variable gain, to control electron shower development within the channels, and/or to provide end-spoiling at the bottom openings of the channels. LMCPs can be fabricated using a laminae-based patterning, assembly, and bonding process, which enables the construction of detector modules with large-area, non-uniform and/or non-planar shapes and structured LMCP channels for specific applications, including process-based responses to different particle types. This laminae-based slab fabrication process and the LMCPs made therefrom are described in detail in U.S. provisional patent application number 63/471,320, the disclosure of which is incorporated herein by reference for the purpose of providing additional details about said process and LMCPs.

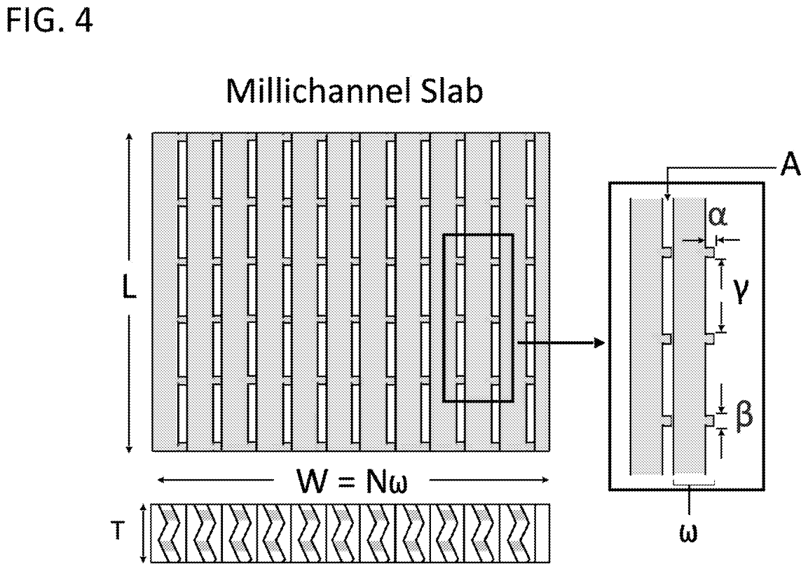

For purposes of illustration, FIG. 3 shows a lamina comprising a simple pattern of structured ridges of height α, width β, and separation γ, to provide multiple channels of dimension α by γ. The shaded areas represent illustrative structured coatings such as for custom secondary electron emission, resistance, or metallization. To form an MCP slab, the laminae are stacked on edge next to each other. MCPs constructed by this method may comprise non-uniform channels, may be of arbitrary shape, and need not be non-planar.

In some embodiments of the gamma ray detectors, the CS and AS are integrated into a single assembly, which offers the advantage of a compact geometry. This can be achieved by an LMCP in which the channels are formed in a layer (or “slab”) of a gamma ray conversion material. By coating the interior surfaces of the channels with a secondary electron emission material and determining voltage distributions within the channels via patterned metallization, the LMCP can be fabricated as both the CS and the AS of a gamma ray detector. The substrate from which the LMCP slab is made may comprise a dielectric material loaded with metal nuclei, such as W or Pb. These include metal-loaded glasses, oxides, and ceramics that function as a converter of gamma rays to electrons via the Compton, Photoelectric, and/or Pair Production effects. Within a single detector, multiple such LMCPs can be stacked for higher conversion efficiency, improved time resolution, higher gain, and pulse saturation.

The integrated CS/AS stages provide high space and time resolutions and enable geometric configurations in which gamma rays traveling in thin layers of the conversion material produce electrons and provide gamma ray conversion efficiencies adequate for lowering the radiation dose to patients in medical imaging.

FIG. 4 shows one example of a slab for an integrated CS/AS assembly intended for gamma ray detection, whereby, by way of illustration, the slab may be made from a heavy metal-containing dielectric, such as Pb-glass. The thickness of the LMCP is equal to the width of a lamina, T. Laminae are stacked on edge such that the ridges form channels between the lamina of dimension α perpendicular to the lamina and y transverse along the lamina. The bulk laminae, which represent the largest fraction of the area of the LMCP slab, serve to convert an incoming gamma ray to a primary electron. Gamma rays are incident on the plane of the LMCP slab and traverse a path length in the conversion material that depends on the thickness and structure of the laminae, the open area ratio (OAR), and the incident angles of the gamma ray from the normal.

The efficiency of LMCP slabs having thicknesses of 1 cm and 2.54 cm (1 inch) for gamma ray conversion based on incident angle is illustrated in the Example, which reports the results of simulations of the direct conversion of gamma rays in the slabs of W and Pb-glass.

### Entrance and Exit Grids

One or more grids may be included in the detectors to focus and/or accelerate primary or secondary electrons toward the dynodes, microchannel plates, or the anodes. These grids are used to apply electron focusing, accelerating, or otherwise modulating electrical fields across the CS, AS, or integrated CS/AS.

The CS may include an entrance grid comprising a thin sheet, a grid, mesh, foils, wires, ribbons, or the like as the first element. The entrance grid supports an electron accelerating or modulating field to the main CS structure. This grid may be coated with a secondary emitter to convert primary electrons emitted in a direction away from the AS to secondary electrons, which are then accelerated to the AS.

The CS may also include an exit grid comprising a thin sheet, a grid, mesh, foils, wires, ribbons, or the like as the last element. The exit grid supports an electron accelerating or modulating field from the main CS structure and, in some applications, to the AS. The distance from the exit grid to the AS can control the capacitance to the exit of a second MCP and can modify the pulse rise and fall times.

### The Amplification Stage (AS)

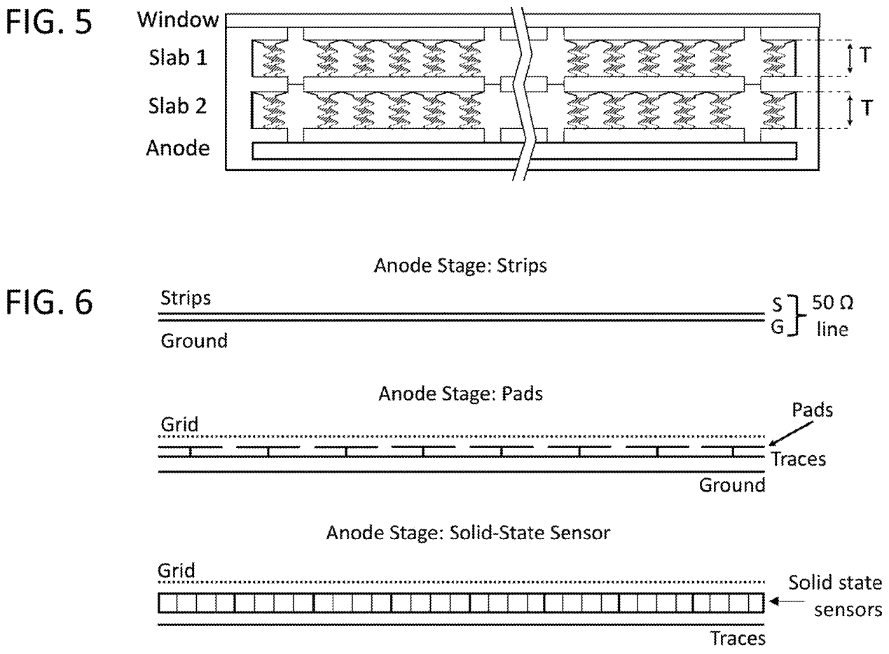

The AS of the gamma ray detectors serves to provide high gain to secondary electrons created by the primary electron in the CS. For applications in which high-resolution timing and spatial resolution are needed, the AS can comprise an amplifier of large area that is compact in the gamma ray incidence direction. One manifestation of such a high-gain AS includes a pair of MCPs in a chevron configuration, as shown in FIG. 5. As described in detail in U.S. provisional patent application number 63/471,320, in some embodiments of the integrated CS/AS assemblies, the CS/As is an LMCP and the entrances of the channels can be shaped and coated to optimize timing and/or the OAR, as represented by the entrance funnels of the micro-channels shown in FIG. 5. The exits of the channels can be shaped to control the angular distribution of electrons exiting the channel pores.

Traditional end-spoiling of the channels can be implemented by metallization. The trajectories of the electrons inside the channel can be optimized for timing and current by optimizing the placement, separation, shape, and voltage of the dynodes within the channels. As one example, the amplification of electrons in the channel can be concentrated at the exit end of the channel, with the predominant channel length used for the conversion of the gamma ray.

In the embodiment of FIG. 5, the stacked LMCPs provide an integrated CS and AS, as described above. However, the CS and AS need not be integrated and stacks of two or more MCPs can be positioned below the CS in detectors in which the CS and AS are provided as separate components. Moreover, it should be noted that the MCPs used in an AS need not be LMCPs. The use of multiple stacked MCPs can provide higher conversion efficiency, improved time resolution, higher gain, and pulse saturation.

When stacks of MCPs are used in the AS, the last MCP in the stack may be made with conventional thin substrates to minimize direct conversion and operated in saturation mode to reduce the variation in pulse height due to conversion at various depths in the converter MCPs preceding it in the stack.

### Anode Stage

The anode stage of the gamma ray detectors includes at least one anode having a vacuum-compatible top surface configured to receive the amplified electron signal. The output charge cloud (i.e., the electron shower) from the AS induces an analog signal on an anode plane, which conveys the signals to electronics that digitize the signals over multiple channels covering the plane. The two orthogonal coordinates in the plane of the anode and the time are recorded.

Various anode designs for the readout of the electron shower are known in the art. Generally, the anode will support multiple electrodes comprising an array of conducting traces, micro-strips, and/or pads for the conveyance of analog signals to one or more connectors penetrating the hermetic package for signal digitization. The traces may be differential or single-ended. In some embodiments of the detectors, the anode stage comprises solid state detectors. The anode will also typically include appropriate DC and capacitively-coupled ground planes and connects to carry return currents and to suppress noise.

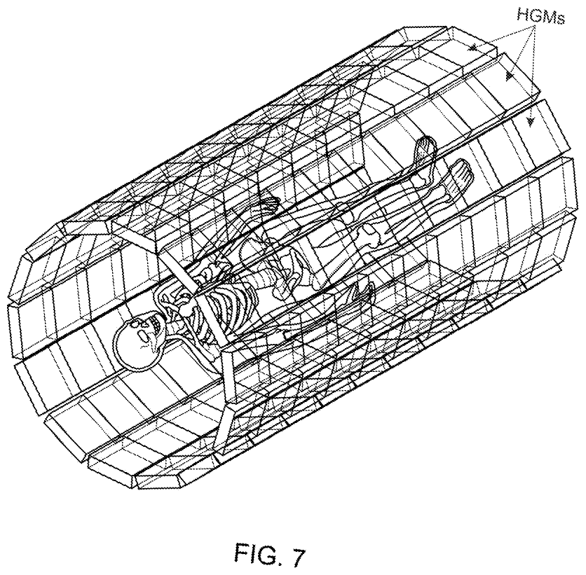

The anode may be single or multiple layered and, depending on the hermetic package, the anode substrate may be composed of glass, ceramic, plastic, or metal, or another material that is compatible with the vacuum requirements. For purposes of illustration, FIG. 6 shows three example implementations of an anode stage.

FIG. 6, top panel, is a schematic diagram of a strip-line anode stage comprising a conducting plane of impedance-controlled RF-microstrips and a corresponding ground plane. The microstrips can be patterned to provide a desired impedance. Additional details regarding RF strip-line anodes for use with MCP-based detectors can be found, for example, in Grabas, Hervé, et al. Nuclear Instruments and Methods in Physics Research Section A: Accelerators, Spectrometers, Detectors and Associated Equipment 711 (2013): 124-131.

FIG. 6, middle panel, is a schematic diagram of an anode stage that includes an entrance grid, a conducting plane of pads, a layer of impedance-controlled signal traces, and a ground shield. The entrance grid, which is electrically controlled and may be comprised of wires, grids, mesh, foils, or other transmissive geometries, is positioned between the exit of the AS and the anode stage electrodes. The grid serves to terminate the field lines from the output of the AS, to provide proximity focusing at the anode plane, to return the current to the AS via direct or capacitive coupling, and to increase the current at the anode. The grid can also be used to modulate the output pulse. The electrically conductive pads may be regular, patterned in size, and/or patterned in shape to enhance charge sharing.

FIG. 6, bottom panel, is an example of an anode stage that comprises an array of solid-state sensors disposed between an entrance grid and one or more layers of impedance-controlled signal traces, and a ground shield (not shown).

### The Package

The housing provides mechanical support, can support a vacuum environment for the detector components, and allows for power and signal transmission. The package may be permanently sealed or comprise O-rings and gaskets. The package will typically include hermetic feedthroughs to enable penetrations for High Voltage (HV), ground, getter activation, and analog signals, and, in some embodiments, one or more tubulations that provide pump ports through which the package can initially be evacuated, to enable continuously pumped detector operation, or to introduce a gas The package and component subsystems may be modular for fast quality control and characterization and minimum assembly time and cost. The package structure may be designed to withstand atmospheric pressure with or without internal support.

Suitable hermetic package materials for the detectors include metal, ceramic, or glass, allowing flexibility and economy of construction. For embodiments of the detectors that do not require an internal vacuum, the housing may be constructed of a light-weight material.

The package may accommodate loading and securing pre-assembled detector modules. In embodiments of the devices in which there are no oxygen-sensitive components, such as a photocathode, sealing of the package can be done at atmospheric pressure (including in ambient air), rather than in vacuum. Large systems comprising multiple particle detectors may be housed within a single package with an appropriate shape. A common packaging for multiple particle detectors enables a higher packing fraction and economies of shared subsystems, including anodes, cabling, and/or electronics, and the ability to seal the housing at atmospheric pressure enables application-specific packaging for multiple detectors that are not limited by considerations for vacuum assembly. While the package shown in FIG. 1 is rectangular with planar surfaces, the package may be non-rectangular and/or non-planar.

The package structure may comprise an upper part and a lower part. In one configuration, the lower part comprises a bottom and side walls that contain the internal detector assembly, and the upper part is a planar element that seals to a sealing surface on the top of the side walls. In an inverted configuration, the bottom is a plane on which an internal detector stack is installed, and the top comprises an inverted box consisting of sidewalls and a top plane. An alternative implementation comprises a top plate, an intermediate frame that forms the sidewalls, and a bottom plate. Features such as pins, vented screws, and ledges on the internal surfaces of the package may enable the installation of pre-assembled detector components as independent modules for subsequent installation.

### High-Resolution Gamma Multiplier Tubes (HGMTs)

A High-Resolution Gamma Multiplier Tube (HGMT) employs Surface Direct Conversion of a gamma ray to a primary electron to achieve high spatial resolution, and in some embodiments, accompanying high time resolution, over large areas of coverage. In an HGMT, the electron amplifier is typically a large-area (e.g., having a sensitive area of at least 25 cm², high-gain (e.g., at least 10⁵) amplification structure, such as one or more MCPs; and, typically, a high-resolution anode capable of high space and time resolutions that enable the determination of the time and two-dimensional position of an incident gamma ray. HGMTs having a time resolution of less than 50 psec and/or a space resolution of less than 1 mm can be constructed.

Due to the absence of a photocathode, in some embodiments of the HGMT said HGMTs can be assembled at atmospheric pressure, including in ambient air. Large-area arrays of HGMT modules can be constructed from discrete HGMT detectors or from arrays of HGMT internal modules in a common vacuum package. An advantage of the latter embodiments is that subsystems may be shared; for example, a continuous strip-line anode may service the CS/AS stages in multiple HGMTs. (See, B. W. Adams, et al., Nucl. Inst. Meth. Phys. Res. A., Vol. 795, 1 (Sept. 2015) for more details regarding strip-line anode designs.)

Large-area arrays of the HGMTs can be made from multiple HGMTs connected in parallel or series. Packing configurations of the HGMTs in an array include close-packed side-by-side arrays, close-packed overlapping arrays for full coverage, sparse side-by-side arrays, and stacks of HGMT one-behind-another for better coverage of electron showers, measurement of the depth of the interaction (DOI) point, increased interaction probability, and/or higher efficiency at lower energies.

For individual HGMTs, the package may be rectangular or in the case of an HGMT that includes a non-rectangular or non-planar MCP, may be otherwise shaped. For example, HGMTs may be housed within a cylindrical housing with an open bore for a PET subsystem or within a large planar vacuum package for a photon/electron pre-sampler in a particle physics experiment.

An HGMT is typically less than about 10 cm thick (e.g. 2.5-10 cm thick) along the path of the gamma ray, depending on the implementation of the gamma ray CS, AS, and anode stages and the mechanical design of the package. For some applications, such as inside the magnet bore in a multi-modality PET detector, the thin aspect ratio allows a smaller-radius magnet and structure over scintillator crystal-based gamma ray detection systems.

The HGMTs can share front-end high bandwidth (≤5 GHz typ.) electronics, such as those used with large-area picosecond photodetectors (LAPPD™), as described in J.-F. Genat, Nucl. Instrum. Meth. A 607:387-393, October, 2009. arXiv:0810.5590; E. Oberla, PSEC4 waveform sampler and Large-Area Picosecond Photo-Detectors read-out electronics: Proceedings of the Workshop on Picosecond Photon Sensors, Clermont-Ferrand, 2014; and E. Oberla, Nucl. Instr. Meth. A 735, 21 Jan., 2014, 452. Pattern recognition for localization of a gamma ray in space and time can be done with local intelligence on each module. In time-of-flight (TOF)-PET, with the identification of the two gamma rays, full event reconstruction can be done in real time using HGMTs. Multiple buffering and the reduced radiation dose made possible by the HGMTs facilitate deadtimeless operation for faster data acquisition.

### HGMTs—Time and Space Resolution

Methods of MCP construction that integrate the CS and AS are made possible, at least in part, by the elimination of the oxygen-sensitive photocathode. The resulting large-area thin detectors can provide improved resolution over particle detectors that rely on photocathodes.

### Improved Space and Time Resolution—Channel Pore Dimensions

The laminae-based approach to LMCP construction provides control over the channel pore shape and size; using this fabrication method, channels having cylindrical, elliptical, square, rectangular, or other-shaped pores can be formed. Moreover, the pore shape and/or size can vary along the length of a channel and the channel-forming surfaces need not be flat. Thus, the channel dimensions can be varied in both directions transverse to the channel. (Additional information regarding the fabrication of LMCPs with non-standard channel shapes, sizes, and non-uniformities can be found in U.S. provisional patent application No. 63/471,320.)

The ability to control channel dimensions in an LMCP enables optimization of the spatial and time resolution of the detectors because the inherent space and time resolutions in an LMCP are dependent on the channel pore dimensions. For example, a typical time resolution for a 20 μm channel is less than 50 psec, and this generally decreases with decreasing pore size. The effect of channel pore dimensions on the resolution of the electron signal is illustrated in the Example, which reports simulated spatial distributions of electrons at the exit plane of an LMCP versus position along both transverse directions of a channel with a rectangular pore shape.

In some embodiments of the HGMTs, the time resolution will be dominated by variations in the drift lengths of the electrons from the location of the creation of the primary electron in the CS to the first strike in a channel of the AS. Fluctuations in drift length can be minimized in embodiments of the HGMTs in which the CS and AS are integrated in the form of an MCP, as described above. Other means of optimizing for the space and time resolution include configuring the CS to minimize fluctuations in drift length, shaping the electric fields in the CS and/or AS, and stacking multiple CS/AS/anode units to limit the drift length

The time resolution for an embodiment of an HGMT in which the CS and AS are integrated in an MCP slab having channels with rectangular pores is illustrated in the Example, which reports the simulated current exiting an MCP channel versus time for an electron shower generated by a gamma ray at normal incidence.

### Improved Space and Time Resolution—the Method of First-One-In Timing (FOI™)

The high gain of the AS and short distances inherent in the gamma ray interaction in the CS enable a method for achieving a high time resolution for the HGMTs. The method, which is referred to herein as First-One-In Timing, rests on two HGMT characteristics. First, the HMGT can achieve a gain of 10⁶-10⁷, which allows the electronics to detect a secondary electron shower from a single electron at the input to the AS. Second, the multiplicity from the secondary emission in the CS is stochastic in nature, and as the multiplicity increases the distribution of arrival times of the first secondary electron to arrive at the anode moves closer to the minimum possible time after the gamma ray is converted. In the limit of a very large number of secondary electrons generated by an initial primary electron traversing the secondary electron emission layer, the time of the pulse at the exit plane of an MCP asymptotically approaches a limiting value from above. Improved time resolution in an HGMT having a CS and AS integrated in an MCP due to a higher multiplicity of initial secondary electrons is demonstrated in the Example, which reports the simulated arrival times for a first secondary electron of an electron shower at the exit plate of the MCP.

### Applications for Gamma Ray Detectors

Applications for the gamma ray detectors, including the HGMTs, include applications that currently employ conventional gamma ray detectors that utilize a scintillator, such as visual imaging, particle detection, medical imaging (e.g., PET and SPECT), and national security. The gamma ray detectors can be used to human and non-human patients and non-living or living samples, such as plants and biological samples.

The general steps for imaging a sample (e.g., a patient or other sample) using a gamma ray detector of a type described herein integrated in a TOF-PET system, include: placing a patient or sample that emits coincident gamma ray pairs (generated by positron-electron annihilation events) between a first gamma ray detector and at least one other gamma ray detector located such that the back-to-back gamma rays intersect the region-of-interest (ROI); detecting coincident gamma-ray pairs arriving at the first and second gamma ray detectors by detecting a secondary electron signal generated in each gamma ray detector when a gamma-ray interacts with a gamma ray conversion material in the detector to produce a primary electron via the Compton or Photoelectric Effect and said primary electron traverses a secondary electron emission material to generate secondary electrons; determining the respective ends of a Line-of-Response (LOR) for the coincident gamma ray pair based on the spatial positions of the gamma ray trajectories in the plane of the gamma ray detectors; determining the spatial position of the positron-electron annihilation event along the LOR based on the arrival times of the two gamma rays measured by the gamma ray detectors. An image of the patient or sample can then be generated based on the spatial distribution of the positron-electron annihilation events.

Illustrative examples of imaging systems for which the gamma ray detectors described herein, including the HGMTs, would provide benefits are described below. These imaging systems can be used to image a variety of body parts, including legs, arms, and brains, and to detect, treat, or monitor a range of diseases or conditions, including cancers. For example, the HGMTs can be employed in imaging systems that produce dynamic movies of the brain, heart, vascular system, or other organ functions in a patient. Because the HGMTs enable low-dose imaging, they can be used for pediatric patients and immune-compromised or other vulnerable patients.

### Whole-Body TOF-PET Scanners at Reduced Radiation Dose

FIG. 7 shows the physical layout of a representative whole-body TOF-PET scanner made with HGMT detectors. The scanner benefits from a reduced radius due to the absence of a layer of scintillator to convert the gamma rays to optical photons, and the absence of the corresponding photodetector system with photocathodes to convert the optical photons to electrons. As the required radial distance for detection is less, the HGMT facilitates integration into multi-modality systems such as PET/MRI and PET/CT. While the dominant effects enabling a reduced radiation dose are the higher efficiency and improved spatial resolution for gamma ray detection from SDC™, the increase in coverage from the elimination of the scintillator and photodetector systems also contribute to the enablement of a lower dose. In addition, their elimination reduces device complexity, improves stability and ease of calibration, and reduces maintenance.

The ability of HGMT-based TOF-PET scanners to reduce the radiation dose needed for imaging a patient is demonstrated in the Example, which reports a simulation of TOF-PET scanning of a phantom by HGMT-based TOF-PET scanners with CS/AS MCPs of different thicknesses radiation doses well below benchmark doses.

### Portable TOF-PET Scanners

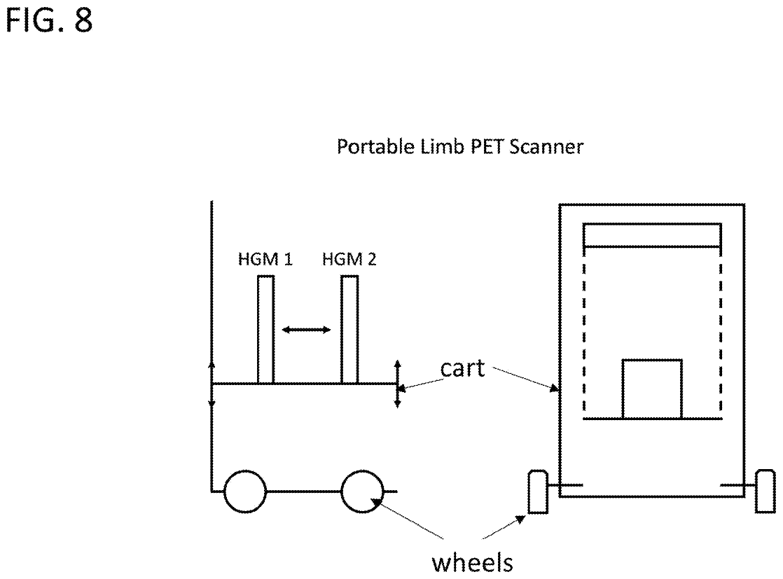

A significantly lower radiation dose allows for the use of portable TOF-PET scanners for imaging applications and facilities for which PET is not currently possible or economical. Examples of such applications include imaging of bone breaks, including hair-line fractures, for which the current standard of X-rays has a significant rate of non-detection, but for which PET has high sensitivity. FIG. 8 shows a sketch of a simple two HGMT-module portable scanner on a portable cart that can be adjusted in height and aperture to accommodate legs and arms, for example. Because the HGMTs do not have a photocathode, they do not need ultra-high vacuum (UHV), and can be pumped with a small vacuum pump located on the cart. The system can be valved off, transported, and restarted at a new location. The flexibility in the TOF-PET design provided by the gamma ray detectors also enables the design of compact scanners with geometrical configurations and dimensions that require little patient preparation and facilitate a fast and convenient scanning experience for the patient, including TOF-PET scanners that scan patients while they are standing up or sitting down and scanners that fit easily into small medical offices.

### Animal TOF-PET Scanners

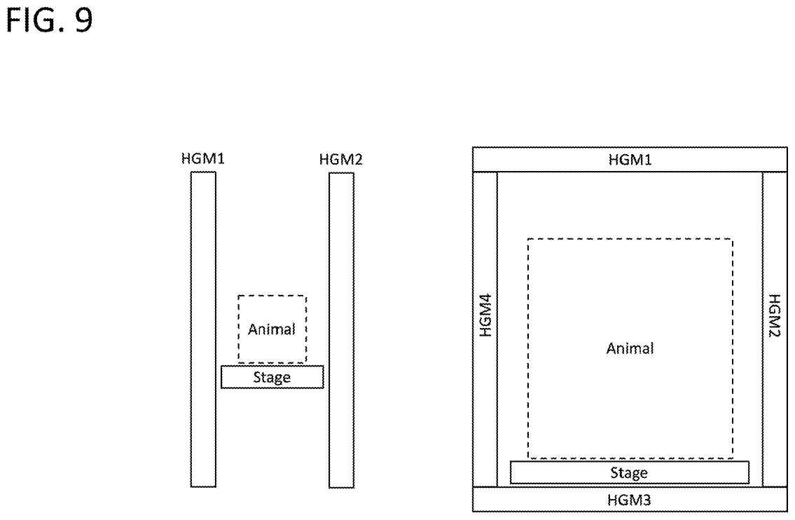

FIG. 9 shows a representative PET scanner for small animals such as might be used in the development of pharmaceuticals. The large area of the HGMT may allow coverage of much of the solid angle with only two HGMTs. An array of multiple HGMTs covering four or six sides can provide coverage for larger animals. Similar small scanners may be employed in the biological sciences and/or agriculture for rapid scanning of small animals, plants, and fungi. Relative to scanners presently in use, these compact scanners can offer faster scan times, higher resolutions, lower doses, lower exposure to radioactivity for those handing the radioactive materials, and higher throughput.

### Shower-Max Detectors

The ‘shower-max’ detector, a plane or system of planes imbedded in a radiator material such as lead allows identification and precision location of high-energy photons and electrons. A multi-plane system measures the well-characterized exponential rise of the electron shower, allowing location of the interaction point and contributing to the energy measurement. (B. Rossi, High Energy Particles; Prentice Hall (1952); ISBN-13: 9780133873245.) The HGMT provides an economical precision implementation of a large-area precision shower-max plane or system of planes.

### Electromagnetic and Hadronic Calorimeter Systems

Electromagnetic and hadronic calorimeters are key elements in detectors in particle, nuclear and space physics. The HGMT allows making energy measurements in successive layers of a calorimeter, and can provide an economical implementation of a large-area calorimeter system. For example, gamma ray detectors of a type described herein can be implemented in a sampling calorimeter of the type described in U.S. Pat. No. 8,604,440, thereby eliminating the need for a scintillator and photodetector.

### Imaging Systems for Other, Non-Medical Scientific or Societal Applications

Other areas where the gamma ray detectors are useful include material research at synchrotron radiation facilities, security applications such as radiation monitoring and fissile material tracking, and other safety applications.

### Neutron Detectors

Surface direct conversion particle detectors can be designed as neutron detectors through the appropriate selection of conversion material. Neutron detectors may have the same basic geometry as the gamma ray detectors described above, but utilize conversion materials that directly convert an incident neutron into recoil particles when the neutron interacts with active elements in the material. These recoil particles then excite secondary electrons when they interact with the secondary electron emission material in the CS or an integrated CS/AS of the type described above. Depending upon factors such as the energy of the neutron, a recoil particle may be, for example, an alpha particle, proton, triton, gamma ray, or fission product. The active elements are typically contained in a dielectric material, such as a glass (e.g., a borosilicate glass or Pb-glass), ceramic, or plastic. Some active elements for the neutron detectors are boron (B), cadmium (Cd), gadolinium (Gd), and lithium (Li). The material density and composition of the neutron conversion material can be selected to optimize neutron conversion, detector timing/space resolution, and mechanical robustness.

Various materials for the conversion of neutrons into recoil particles are known. These include hydrogen-rich plastics or glasses loaded with light isotopes, such as ¹⁰B or ⁷Li, Cd, Gd, or fissionable heavy nuclei such as U₂₃₅.

By way of illustration only, glass loaded with ¹⁰B can produce an alpha particle and a 480 keV gamma ray. More details regarding some examples of neutron conversion materials can be found in: Anton S. Tremsin. W. Bruce Feller, and R. Gregory Downing. “Efficiency optimization of microchannel plate (MCP) neutron imaging detectors. I. Square channels with 10B doping.” Nuclear Instruments and Methods in Physics Research Section A: Accelerators, Spectrometers, Detectors and Associated Equipment 539.1-2 (2005): 278-311; Beaulieu, D. R., et al. “Novel fast neutron counting technology for efficient detection of special nuclear materials.” 2009 IEEE Conference on Technologies for Homeland Security. IEEE, 2009, and Radiation Detection and Measurement; Glenn F Knoll; Wiley; 4^{th} ed (2010) ISBN 978-0-470-13148-0; and Radiation Detection and Measurement; Glenn F Knoll; Wiley; 4^{th} ed (2010) ISBN 978-0-470-13148-0.

By way of further illustration, fast neutron (~1 MeV) detection can be accomplished through the direct conversion of a fast incident neutrons into a recoil proton via the neutron-proton (n-p) recoil reaction within a hydrogen-rich (e.g., plastic) conversion material. The recoil proton has a short range in dielectric material and will excite secondary electrons as it exits the dielectric material and traverses a secondary electron emission material in the CS. The secondary electrons can then be amplified by the AS, which may be integrated with the CS as a single unit or may be a separate and distinct component, as described above.

Alternatively, to detect thermal neutrons (~0.025 eV), the neutron conversion material can incorporate high-efficiency neutron conversion active elements such as ¹⁰B or ¹⁵⁷Gd, providing a high neutron stopping power. For example, by incorporating ¹⁰B into the dielectric, the neutron conversion reaction produces ⁷Li (1.01 MeV) and a recoil alpha particle (1.8 MeV) (6%) or ⁷Li (0.84 MeV) an alpha particle (1.47 MeV) and a gamma ray (0.48 MeV) (94%). The alpha particles produced in either reaction have a short range (3.5 mm) in the dielectric and will excite secondary electrons as they exit the dielectric material and traverse a secondary electron emission material in the CS. The secondary electrons can then be amplified by the AS, which may be integrated with the CS as a single unit or may be a separate and distinct component, as described above.

More details regarding LMCPs comprising slabs of neutron conversion materials that can be used as an integrated CS and AS can be found in U.S. provisional patent application No. 63/471,320.

The anodes for reading out the secondary electron signal, the supporting electronics, and package for the neutron detectors may be the same as those described above for the gamma ray detectors.

Some embodiments of the particle detectors are capable of simultaneous precision measurements of gamma rays and neutrons in high-radiation environments.

### Photon and Electron Detectors

The particle detectors can be designed as MCP-based electron or photon multipliers by using MCP substrates (e.g., laminae) that are dielectric materials commonly used in MCPs. Considerations of versatility of response, lower cost, higher packing fraction, ease of construction, and assembly at atmospheric pressure may allow broad use in tracking, calorimeter, and shower-max systems.

The electron multipliers may be used in conjunction with a photocathode to convert photons to electrons for multiplication in the AS. In some embodiments, a grid is placed between the photocathode and the entrance surface of the closest MCP. In some embodiments, one or more grids are used to separately control the field at the photocathode and the entrance of the MCP channels.

### EXAMPLE

The principle of operation and advantages of HGMT detectors based on the direct conversion of a gamma ray into a primary electron via the photoelectric effect using W or Pb-glass conversion materials in an LMCP slab of the type shown in FIG. 4 are illustrated in this Example. The data presented here is from a detailed study of the conversion of the gamma ray and the subsequent tracking of the primary electron and secondary electrons through the HGMT using an adapted Tool for Particle Simulation (TOPAS) framework. The TOPAS framework was also used to simulate detector systems, such as whole-body PET scanners. In addition, a simulation using the modified TOPAS framework and its interface to an XCAT phantom package provided a simulation of a multi-module HGMT-based Time-of-Flight Positron Emission Tomography (TOF-PET) detector.

More information about the use of TOPAS for particle simulations can be found in B. Faddegon, et al., European Journal of Medical Physics; Volume 72, P114-121, April (2020) and at the TOPAS home page at https://sites.google.com/a/topasmc.org/home/home. Complete user documentation can be found at: https://topas.readthedocs.io/en/latest/getting-started/intro.html. The low-energy packages Penelope and Option 4 are further described in https://geant4.web.cern.ch/node/1731. Additional information about the XCAT phantom can be found in Segars. W. Paul, et al. Medical physics 37.9(2010): 4902-4915.

### Primary Electron Energy Spectrum

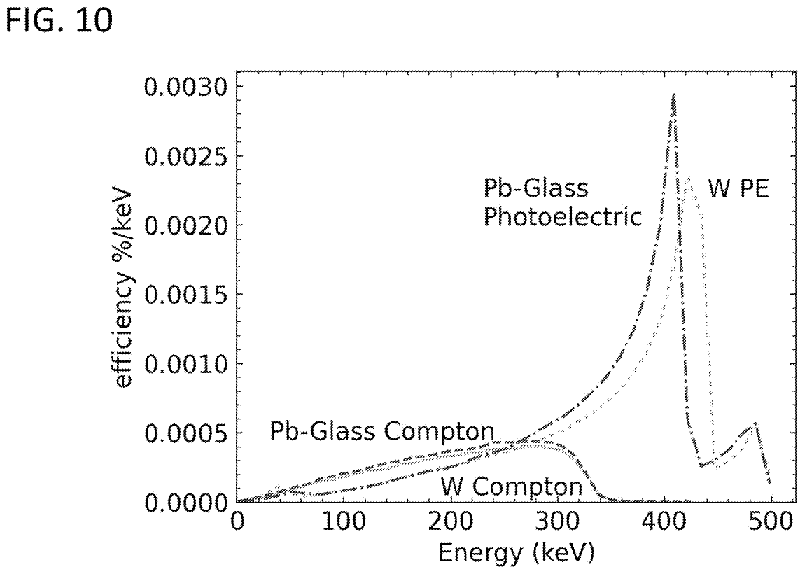

The energy and angular spectra of primary electrons in tungsten (W) and lead-glass (Pb-glass) were determined using the TOPAS simulation. FIG. 10 shows the predicted electron energy spectrum from the exit side of a thin plate of the W or Pb-glass resulting from an interaction with a 511 keV gamma ray at normal incidence. The plate thickness for Pb-glass (λ_{R}=0.561 cm) was 150 microns (0.006″) and for pure tungsten (W; λ_{R}=0.350 cm) was 50 microns (0.002″). As seen in FIG. 10, the Photoelectric Effect dominates; the features correspond to the binding energies of the atomic K and L shell electrons.

### Primary Electron Yield vs Thickness for Metal and Dielectric Plates

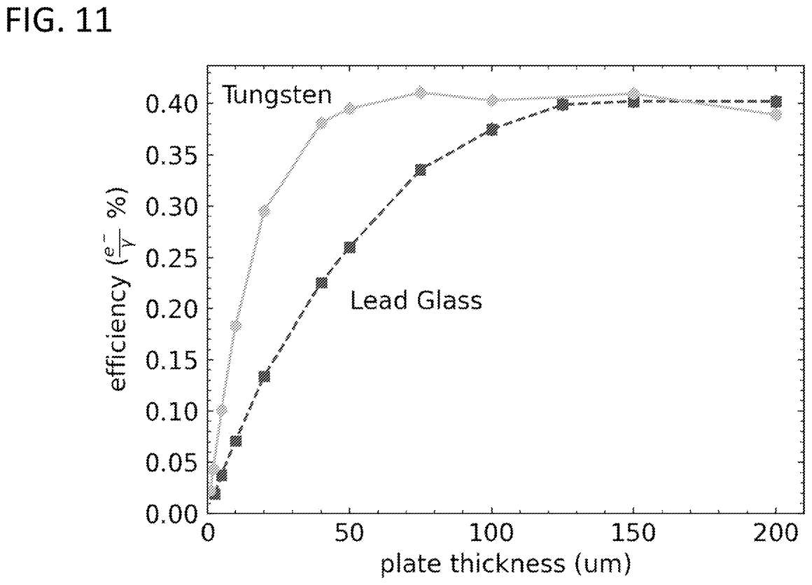

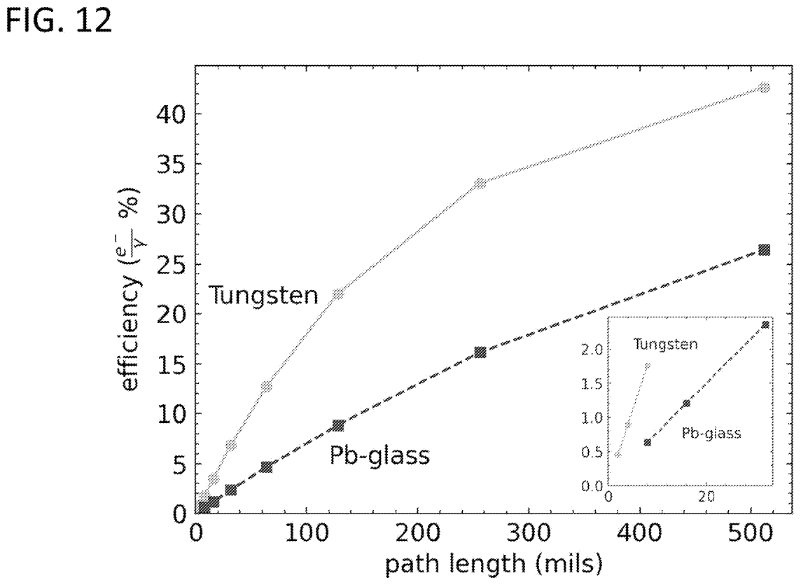

FIG. 11 shows the predicted electron yield per 511 keV gamma ray traversing a thin plate of W (solid line) or Pb-glass (dashed line) at normal incidence versus plate thickness. The yield is for the exit side of the plate. At the plateau values for the two materials, the lower density of the Pb-glass is compensated by the larger depth from which electrons reach the surface. The yield of electrons versus path length in a 50 micron-thick W sheet (solid line) or a 150-micron Pb-glass ribbon (dashed line) for a gamma ray propagating inside the plate is shown in FIG. 12. The yield includes electron emission from both sides of the plate.

### Efficiency of Direct Gamma Ray Conversion in Dielectric Laminae With Surface Channels

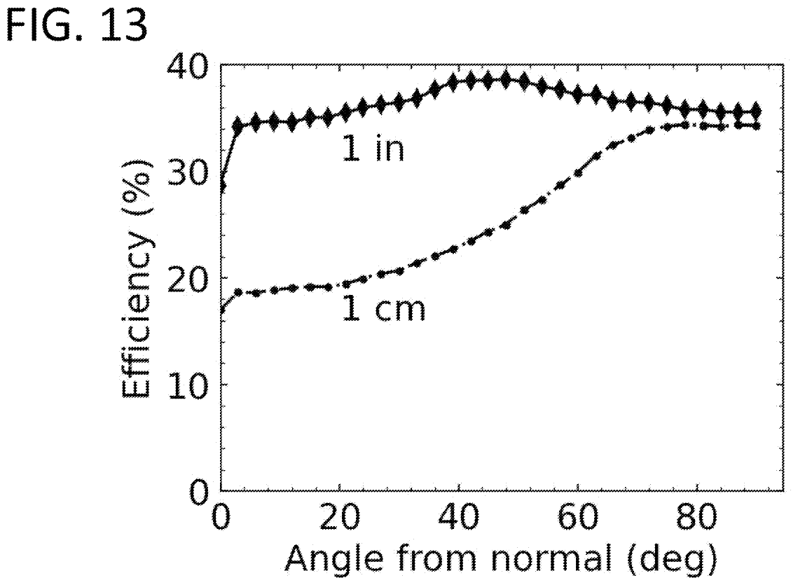

FIG. 13 displays the efficiency for direct conversion of a 511 keV gamma ray versus incident angle o from the normal, where o is the angle in the plane perpendicular to the plane of the individual laminae, for an LMCP having slab thicknesses of 1 cm and 2.54 cm (1 inch), based on the TOPAS simulation. The efficiency includes the creation of a primary electron that enters a channel by crossing a functionalized channel-defining wall.

### Spatial Resolution of an HGMT with CS and AS Integrated in an LMCP

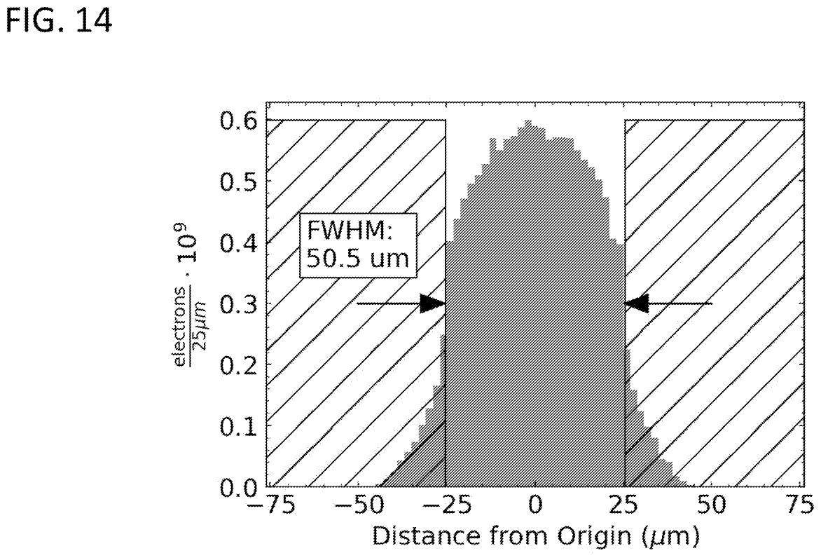

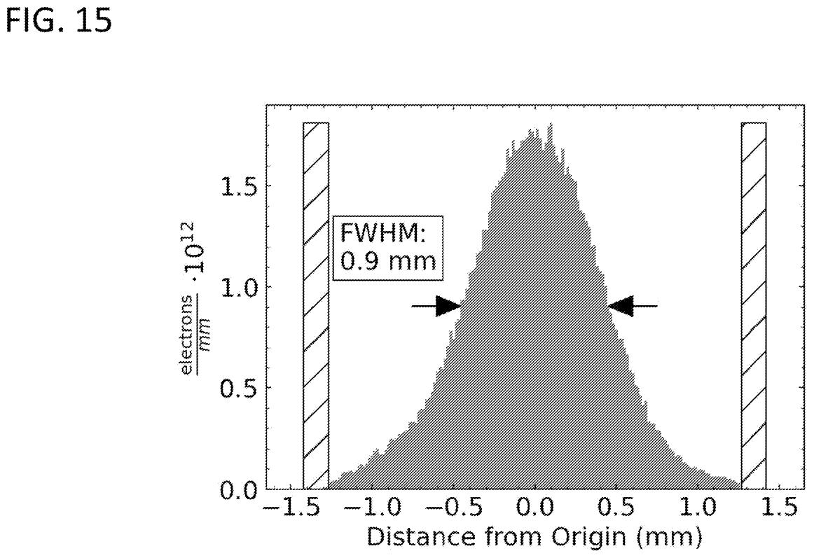

FIGS. 14 and 15 show the one-dimensional spatial distribution of secondary electrons (generated by a single primary electron) at the slab exit plane for an LMCP having channels with rectangular pores, of the type shown in FIG. 4, versus position in the short and long transverse directions for a channel with transverse dimensions of 50 μm by 2.5 mm. The TOPAS simulation of the secondary emission and multiplication was initiated at the point of a primary electron on the wall of the channel (left-hand surface in FIG. 4). The cross-hatched regions represent the spacers between neighboring channels. The full-width half-maximum (FWHM) resolutions (2.3 σ) are 51 and 900 microns, respectively.

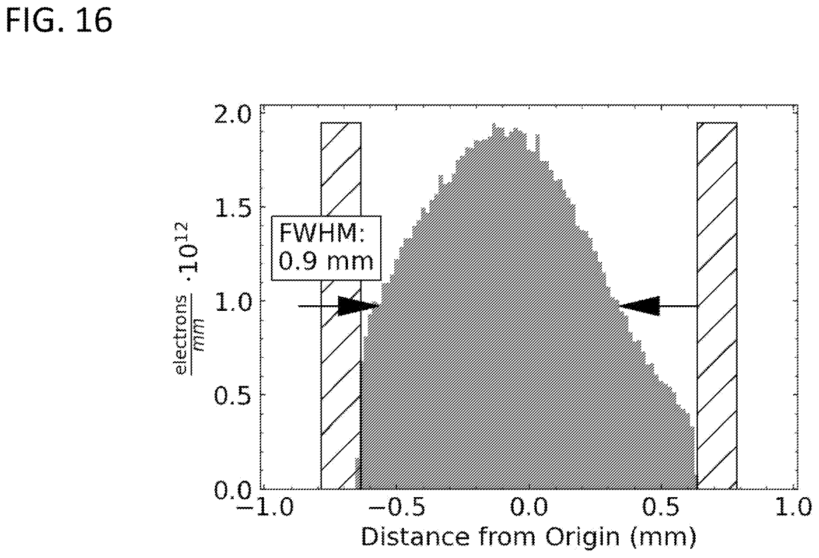

FIG. 16 shows the one-dimensional spatial distribution of secondary electrons at the slab exit plane for an LMCP with the long direction half of the above, i.e., channels of 50 μm by 1.25 mm. The FWHM resolution is the same, but with the tails cut off by the channel walls.

### Temporal Resolution of an HGMT with CS and AS Integrated in an LMCP

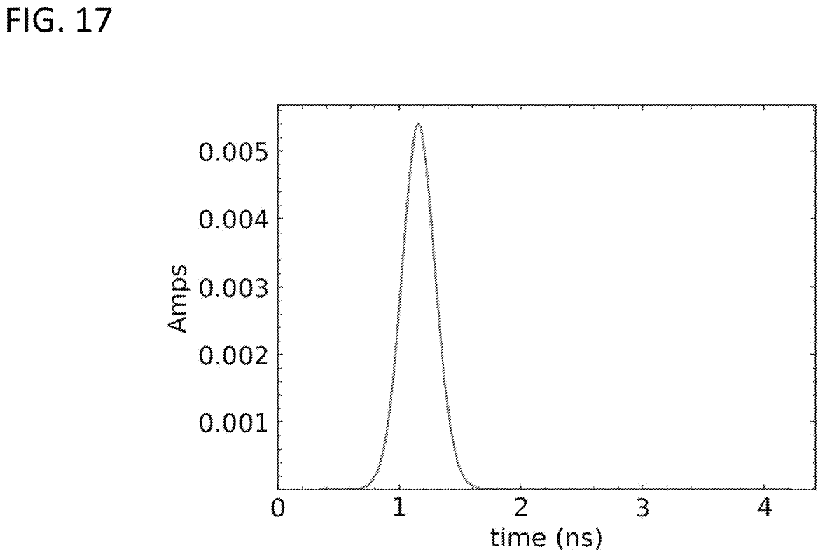

FIG. 17 shows the current exiting a channel in an LMCP of the type shown in FIG. 4 versus time for a signal generated by one gamma ray at normal incidence, based on the TOPAS simulation. The zero point of the time axis corresponds to the projected time the gamma ray would arrive at the anode plane.

### First-One-In Timing

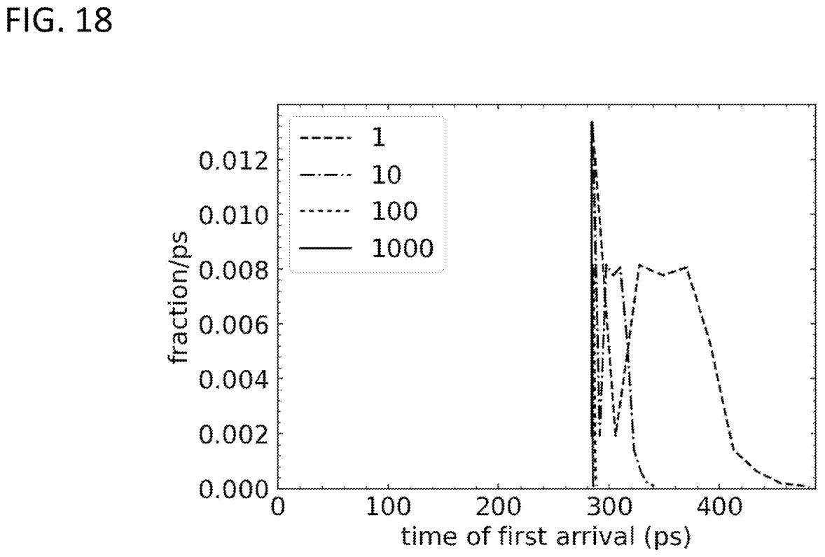

FIG. 18 shows the TOPAS simulation of the time that a first secondary electron of an electron shower in one channel arrives at the exit plane of the Pb-glass slab of the LMCP shown in FIG. 4 versus the number of secondary electrons created by the direct conversion of an incident gamma ray.

The simulation included primary conversion of the gamma ray and secondary emission in the dynodes of the CS. As the multiplicity of secondary electrons increases, the number per unit time increases, and the probability that no electron arrives in a fixed time interval after the gamma ray trajectory reaches the AS decreases exponentially with multiplicity due to Poisson statistics. The separate distributions show the time-of-arrival for increasing multiplicities.

### Simulation of a Derenzo Phantom Illustrating Reduced Radiation Doses

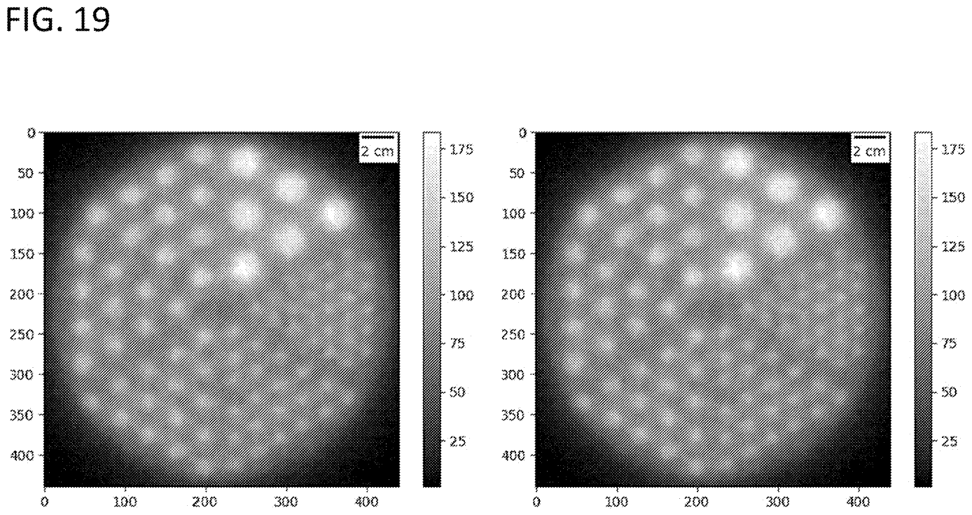

A simulation of a Derenzo phantom was used to illustrate the ability to generate images with a reduced radiation dose for direct gamma ray conversion-based detectors. FIG. 19 shows reconstructed images of a Derenzo phantom at a dose of 150 Bq/mL for the rods, a factor of 100 lower than a benchmark dose. (R. D. Badawi, et al.; J Nucl. Med. 2019 Mar; 60(3): 299-303.) The thickness of the gamma conversion slab in the LMCP (FIG. 4) was 1 cm in the left-hand image and 2.54 cm (1 inch) in the right-hand image. In both cases the background dose was set to ⅓ of that of the rods. The timing resolution was taken as 100 ps (FWHM); the spatial resolution in the plane of the LMCP at the channel exit was conservatively set to 1 mm in both the ‘long’ and ‘short’ dimensions (see FIGS. 14 and 15).

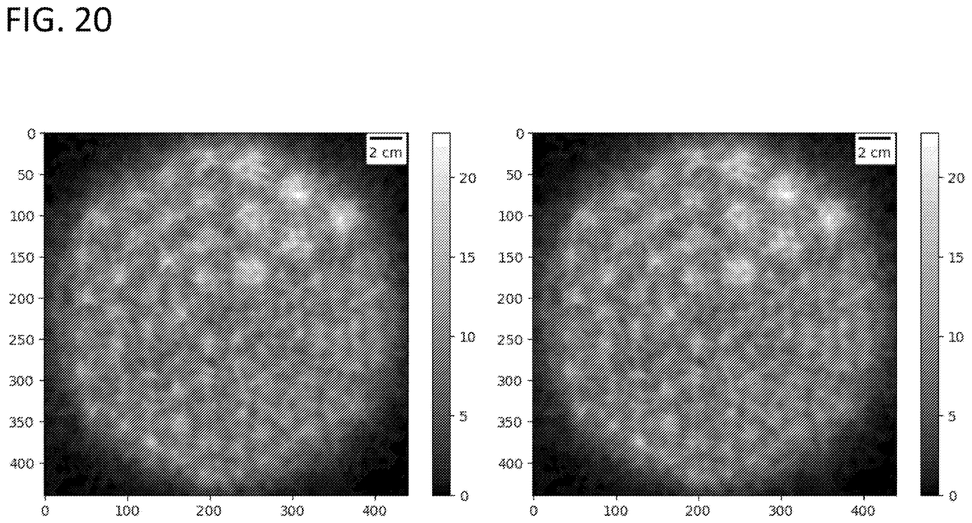

FIG. 20 shows reconstructed images of the Derenzo phantom at a dose of 15 Bq/mL for the rods, a factor of 1000 lower than the benchmark dose. The thickness of the gamma conversion slab in the LMCP (FIG. 4) was 1 cm in the left-hand image, and 2.54 cm (1 inch) in the right-hand image. In both cases the background dose was set to ⅓ of that of the rods. The timing resolution was taken as 100 ps (FWHM); the spatial resolution in the plane of the LMCP at the channel exit was set to 1 mm in both the ‘long’ and ‘short’ dimensions (see FIGS. 14 and 15).

### Simulation of an XCAT Brain Phantom and Two-cm Lesion at Reduced Radiation Doses

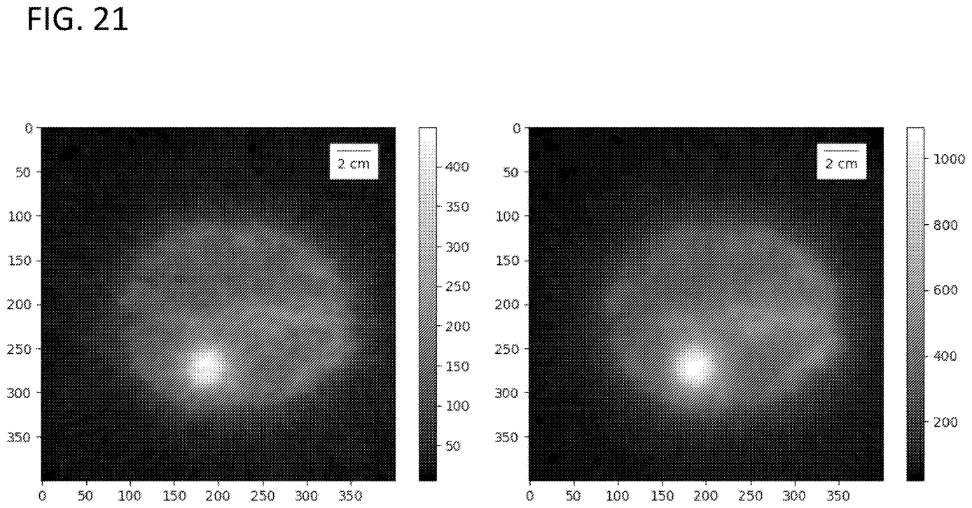

An XCAT brain phantom was simulated at reduced radiation doses. Benchmark doses were taken to be: 8.25 kBq/mL for white matter; 33 kBq/mL for gray matter; and 99 kBq/mL for the spherical lesion. (E. E. Verwer et al., European Journal of Nuclear Medicine and Molecular Imaging 48, 8;2856-2870; 2021.) FIG. 21 shows reconstructed images of the XCAT brain phantom with a 2 cm lesion at a dose reduced by a factor of 100 from the benchmark, i.e., 82.5 Bq/mL for white matter, 330 Bq/mL for gray matter, and 990 Bq/mL for the lesion. The left-hand panel images were reconstructed from direct conversion in a Pb-glass laminated LMCP of thickness 1 cm (FIG. 4). The right-hand panel is for a thickness of the Pb-glass laminated LMCP of 2.54 cm (1 inch) (FIG. 4).

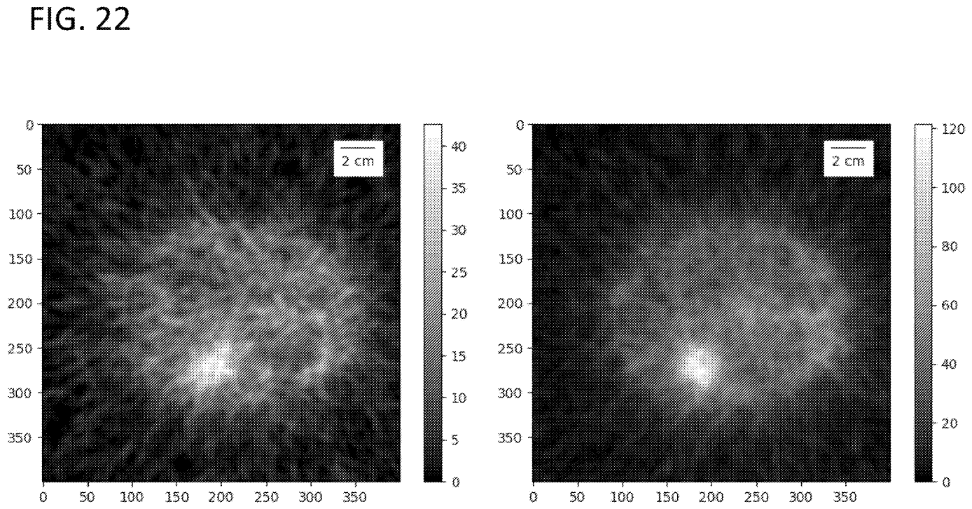

FIG. 22 shows reconstructed images of the XCAT brain phantom with a 2 cm lesion at a dose reduced by a factor of 1000 from the benchmark, i.e., 8.25 Bq/mL for white matter, 33 Bq/mL for gray matter, and 99 Bq/mL for the lesion. The left-hand panel images are reconstructed from direct conversion in a Pb-glass laminated LMCP of thickness 1 cm. The right-hand panel is for a thickness of the Pb-glass laminated LMCP of 2.54 cm (1 inch).

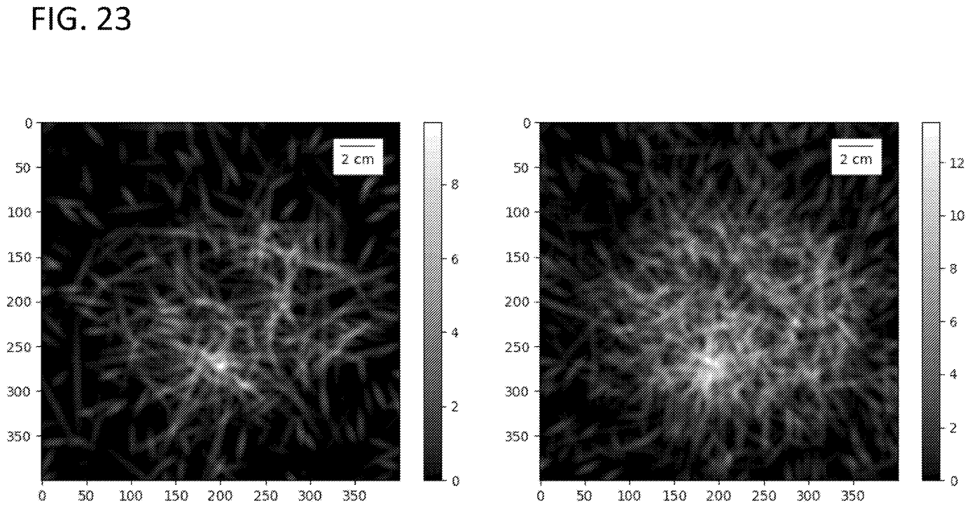

FIG. 23 shows reconstructed images of the XCAT brain phantom with a 2 cm lesion at a dose reduced by a factor of 10,000 from the benchmark, i.e., 0.825 Bq/mL for white matter, 3.3 Bq/mL for gray matter, and 9.9 Bq/mL for the lesion. The left-hand panel images are reconstructed from direct conversion in a Pb-glass laminated LMCP of thickness 1 cm. The right-hand panel is for a thickness of the Pb-glass laminated LMCP of 2.54 cm (1 inch). While the image may not be good enough for detailed diagnosis, the image may be enough to suggest a follow-up scan at a higher dose and may inform strategies for regular screening of appropriate populations, such as selective annual exams for breast cancer.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

1. A gamma ray detector comprising:
a gamma ray conversion stage comprising: a gamma ray conversion material that converts incident gamma rays directly into primary electrons via a Compton, Photoelectric, and/or Pair Production effect; and a secondary electron emission material that converts the primary electrons into secondary electrons to produce a secondary electron signal; and
at least one anode configured to receive the secondary electrons and to convert the secondary electron signal into an electrical signal.

2. The gamma ray detector of claim 1, wherein the conversion material is characterized in that, when gamma rays are incident upon the gamma ray conversion material, the primary electrons are created at a depth below a surface of the gamma ray conversion material that is sufficiently shallow that the probability of the primary electrons penetrating the surface and entering the secondary electron emission material is greater than 10%, as determined by the electron energy and the radiation length of the gamma ray conversion material.

3. The gamma ray detector of claim 1, further comprising an electron amplification stage configured to amplify the secondary electron signal before the secondary electron signal reaches the at least one anode.

4. (canceled)

5. The gamma ray detector of claim 3, wherein the gamma ray conversion stage and the electron amplification stage are separate stages.

6. (canceled)

7. (canceled)

8. The gamma ray detector of claim 3, wherein the gamma ray conversion stage and the electron amplification stage are integrated together in a unit, the unit comprising a microchannel-defining slab having a plurality of microchannels extending therethrough and comprising the gamma ray conversion material, wherein interior surfaces within the microchannels are coated with the secondary electron emission material.

9. The gamma ray detector of claim 1, further comprising one or more grids configured to focus or accelerate the primary or secondary electrons toward the at least one anode.

10. The gamma ray detector of claim 1, wherein the gamma ray conversion material comprises a glass, a ceramic, or a plastic or a metal.

11. (canceled)

12. The gamma ray detector of claim 1, wherein the secondary electron emission material is characterized in that it produces a secondary emission yield (SEY) greater than or equal to 2 upon conversion of the primary electrons into secondary electrons.

13. The gamma ray detector of claim 1, wherein the secondary electron emission material comprises a metal oxide or carbon.

14. A method of detecting a gamma ray using the gamma ray detector of claim 1, the method comprising:
exposing the gamma ray conversion material to an incident gamma ray, whereby said incident gamma ray is converted directly into a primary electron via a Compton, Photoelectric, and/or Pair Production effect;
converting the primary electron into secondary electrons in the secondary electron emission material to produce a secondary electron signal; and
detecting a time that the first secondary electron of the secondary electron signal generated by the gamma ray arrives at the at least one anode.

15. A Time-of-Flight Positron-Emission Tomography (TOF-PET) detector comprising:
a plurality of gamma ray detectors of claim 1; and
electronic circuitry configured to read out secondary electron signals from the at least one anode of the gamma ray detectors and generate an image based on the secondary electron signals.

16. The TOF-PET detector of claim 15 having a spatial resolution of 1 mm or better and a temporal resolution of 100 psec or better.

17. The TOF-PET detector of claim 15, wherein the plurality of gamma ray detectors are arranged around a central volume that is configured to accommodate at least a part of a human or non-human animal for imaging.

18. A method of generating an image using the TOF-PET system of claim 15, the method comprising:
placing a patient or sample that emits coincident gamma ray pairs, generated by positron-electron annihilation events, between a first one of the gamma ray detectors and a second one of the gamma ray detectors;
detecting coincident gamma-ray pairs arriving at the first and second gamma ray detectors by:
detecting a signal generated when a first gamma ray of a coincident gamma ray pair interacts with the gamma ray conversion material in the first detector to produce a primary electron via the Compton, Photoelectric, and/or Pair Production effect and said primary electron interacts with the secondary electron emission material in the first gamma ray detector to produce secondary electrons; and
detecting a signal generated when a second gamma ray of the coincident gamma ray pair interacts with the gamma ray conversion material in the second detector to produce a primary electron via the Compton or Photoelectric Effect and said primary electron interacts with the secondary electron emission material in the second gamma ray detector to produce secondary electrons;
determining ends of a Line-of-Response (LOR) for the coincident gamma ray pair based on spatial positions of trajectories of the first and second gamma rays in the gamma ray conversion materials of the first and second gamma ray detectors;
determining a spatial position of a positron-electron annihilation event along the LOR based on arrival times of the first and second gamma rays measured by the first and second gamma ray detectors; and
generating an image of a region-of-interest within the patient or sample based on a spatial distribution of the positron-electron annihilation events.

19. (canceled)

20. A neutron detector comprising:
a neutron conversion stage comprising: a neutron conversion material that converts incident neutrons directly into a non-photon particle or nuclei; and a secondary electron emission material that converts the non-photon particle or nuclei into secondary electrons to produce a secondary electron signal; and
at least one anode configured to receive the secondary electrons and to convert the secondary electron signal into an electrical signal.

21. The neutron detector of claim 20, wherein the non-photon particles or nuclei are alpha particles, protons, tritons, electrons, positrons, gamma rays, or fission products.

22. The neutron detector of claim 20, further comprising an electron amplification stage configured to amplify the secondary electron signal before the secondary electron signal reaches the at least one anode.

23. (canceled)

24. (canceled)

25. (canceled)

26. (canceled)

27. The neutron detector of claim 20, further comprising one or more grids configured to focus or accelerate the secondary electrons toward the at least one anode.

28. The neutron detector of claim 20, wherein the neutron conversion material comprises hydrogen, deuterium, boron, lithium cadmium, gadolinium, or uranium-235.

29. A method of making the gamma ray detector of claim 1, the method comprising: assembling the gamma ray conversion stage, the amplification stage, if present, and the anode in a package at atmospheric pressure; and sealing the package.

30. (canceled)
